(19) United States
(12) Patent Application Publication
(10) Pub. No.: US 2022/0149345 A1
(43) Pub. Date: May 12, 2022

(54) LI-ION BATTERY ELECTRODE PIECE

(71) Applicant: DONGGUAN AMPEREX TECHNOLOGY LIMITED, Dongguan City (CN)

(72) Inventors: Zhaoyong SUN, Dongguan City (CN); Can NIE, Dongguan City (CN)

(73) Assignee: DONGGUAN AMPEREX TECHNOLOGY LIMITED, Dongguan City (CN)

(21) Appl. No.: 17/583,514

(22) Filed: Jan. 25, 2022

Related U.S. Application Data
(63) Continuation of application No. 15/276,039, filed on Sep. 26, 2016.

(30) Foreign Application Priority Data
Mar. 24, 2016 (CN) 201620233801.7

(51) Int. Cl. H01M 4/13; H01M 10/0525; H01M 50/531

(52) U.S. Cl. CPC H01M 4/13; H01M 50/531; H01M 10/0525

(57) ABSTRACT

A Li-ion battery electrode piece, including an electrode piece substrate, a blank foil and an adhesive piece, the blank foil is arranged at one end of the electrode piece substrate along the length direction of the electrode piece substrate, one end of the blank foil away from the electrode piece substrate has a right-angle area, the adhesive piece is adhered at the right-angle area. The Li-ion battery electrode piece provided, through adhering an adhesive piece on the blank foil, avoids the end of the electrode piece from being deformed and folded, and improves the phenomenon of convex in battery core appearance and bad streak.

### CROSS-REFERENCE TO RELATED APPLICATIONS

This application is a continuation application of the U.S. patent application Ser. No. 15/276,039, filed on Sep. 26, 2016, which is incorporated herein by reference in its entirety.

### TECHNICAL FIELD

The present application relates to a Li-ion battery electrode piece, particularly relates to an electrode piece which reduces folding phenomenon during material feeding through adhering an adhesive piece at the end of a blank foil.

### BACKGROUND

According to design requirements of soft pack Li-ion battery, a portion of the end of the electrode piece needs to be reserved for the blank foil, however, since the thickness of the coating area differs from the thickness of the blank foil, a tension is generated in the preceding process of cold pressing, when feeding during coiling, the tension is released, the end of the electrode piece will warp slightly and deform, the warped electrode piece will rub and touch the isolating film, causing the folding phenomenon. After folding, the edge distance positioning of the electrode tab will be changed, which affect the edge distance control of the battery core, in the meantime, the folding also affects the appearance of the battery core, and will cause convex in appearance and bad streak.

### SUMMARY

The present application provides a Li-ion battery electrode piece, which solves the problem that the electrode piece is easy to fold when feeding during coiling.

The present application provides a Li-ion battery electrode piece, including an electrode piece substrate, a blank foil and an adhesive piece, the blank foil is arranged at one end of the electrode piece substrate along a length direction of the electrode piece substrate, one end of the blank foil away from the electrode piece substrate is provided with a right-angle area, the adhesive piece is adhered at the right-angle area.

In some embodiments, the adhesive piece is aligned with edges of the right-angle area.

In some embodiments, the blank foil is of a sheet structure, and has two main flat surfaces, the right-angle area is located at the main flat surface of the blank foil, at least one main flat surface is adhered with the adhesive piece.

In some embodiments, the adhesive piece is an integral adhesive piece, the integral adhesive piece is adhered on the blank foil along a width direction of the electrode piece substrate, and covers all the right-angle areas of the main flat surface.

In some embodiments, the adhesive piece is a split type adhesive piece, which covers each right-angle area of the main flat surface, respectively.

In some embodiments, the blank foil is of a sheet structure, and has two main flat surfaces, the right-angle area is located at the main flat surface of the blank foil, the adhesive piece is a split type adhesive piece, a part thereof is adhered at a right-angle area of the main flat surface, another part is adhered on a right-angle area of the main flat surface, and the two right-angle areas are staggeredly arranged with respect to the blank foil.

In some embodiments, thickness of the adhesive piece is less than thickness of the electrode piece substrate.

In some embodiments, an electrode tab is further included, the electrode tab is arranged on the blank foil, a part of the blank foil is located at a side of the electrode tab away from the electrode piece substrate, size of the part along the length direction of the electrode piece substrate is 1-5 times of size of the adhesive piece along the same direction.

In some embodiments, size of each part of the split type adhesive piece along the width direction of the electrode piece substrate is at least ¼ of width of the electrode piece substrate.

In some embodiments, the adhesive piece is an adhesive paper, the adhesive paper is a polyethylene terephthalate adhesive paper.

The technical solution provided by the present invention can reach the following beneficial effect:

The Li-ion battery electrode piece provided by the present application, through adhering an adhesive piece on the blank foil, avoids the end of the electrode piece from being deformed and folded, and improves the phenomenon of convex in battery core appearance and bad streak.

It should be understood that, the above general description and the following detailed description are only exemplarily, which cannot limit the present application.

### BRIEF DESCRIPTION OF DRAWINGS

FIG. 1 is a first schematic diagram of adhering an adhesive piece on a Li-ion battery electrode piece provided by an embodiment of the present application.

FIG. 2 is a schematic diagram two of adhering an adhesive piece on a Li-ion battery electrode piece provided by an embodiment of the present application.

FIG. 3 is a schematic diagram showing two adhesive pieces that are respectively arranged on two opposite main flat surfaces provided by an embodiment of the present application.

1. Electrode piece substrate; 2. Blank foil; 3. Electrode tab; 4. Adhesive piece.

The drawings here are incorporated in the specification, which constitutes a part of the specification, showing the embodiments corresponding to the present application, and are used to explain the principle of the present application together with the specification.

### DETAILED DESCRIPTION

The present application will be described in further detail through specific embodiments and accompany drawings. The “front”, “back”, “left”, “right”, “up”, “down” are referring to the placing state of the electrode piece of the Li-ion battery in the drawings.

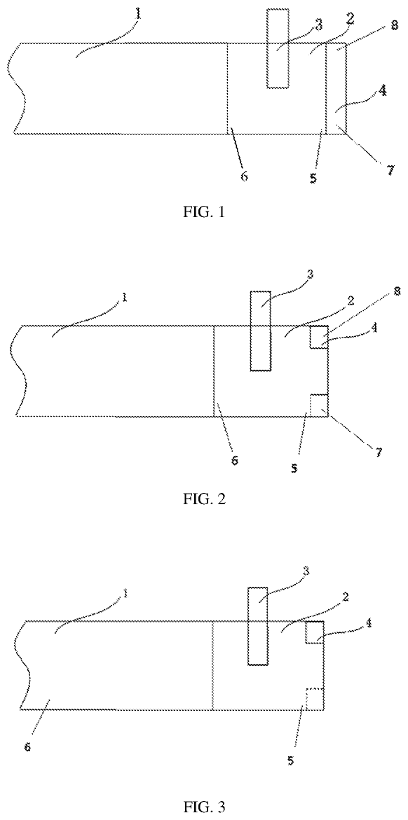

As shown in FIG. 1, the present application provides a Li-ion battery electrode piece, which includes an electrode piece substrate 1, a blank foil 2 and an adhesive piece 4, the blank foil 2 is arranged at one end of the electrode piece substrate 1 along the length direction of the electrode piece substrate 1. The electrode piece substrate 1 is a part of the electrode piece coated with an active material, the blank foil is a part of the electrode piece without coating the active material. A portion of the end of the existing Li-ion battery electrode piece is reserved for the blank foil, since the thickness of the coating area differs from the thickness of the blank foil area, a tension is generated in the preceding process of cold pressing, when feeding the Li-ion battery electrode piece during coiling, the tension is released, the blank foil 2 at the end of the electrode piece will warp slightly and deform, the warped electrode piece will rub and touch the isolating film, causing the folding phenomenon. The Li-ion battery electrode piece of the present application also includes an electrode tab 3, the electrode tab 3 is arranged on the blank foil 2, after folding, the edge distance positioning of the electrode tab 3 will be changed, which affect the edge distance control of the battery core, and the folding also affects the appearance of the battery core, and will cause convex in appearance and bad streak.

In order to prevent folding of the electrode piece, the present application adopts the manner of adhering an adhesive piece 4 on the edge of the blank foil 2. The blank foil 2 comprises a first end 5 and a second end 6. The first end 5 is away from the electrode piece substrate 1, and the second end 6 is close to the electrode piece substrate. The blank foil closed to the first end 5 contains a plurality of corners 7, 8 with a right angle so that a right-angle area is formed at each of the plurality of corners 7, 8. The blank foil 2 is of a sheet structure, which has two main flat surfaces, the right-angle area is located at the main flat surface of the blank foil 2, the adhesive piece 4 is at least adhered at the right-angle area, in a preferred embodiment, the adhesive piece 4 can be aligned with the edge of the right-angle area, thus, when performing coiling, the alignment of the adhesive piece 4 and the edge of right-angle area of the blank foil 2 can further enhance the intensity of the end of the blank foil 2, which restrains the blank foil 2 from releasing the tension, so as to guarantee that the blank foil 2 will not fold.

In the present application, at least one main flat surface is adhered with an adhesive piece, the adhesive piece can be an integral adhesive piece, the integral adhesive piece is adhered on the blank foil 2 along the width direction of the electrode piece substrate, and covers all the right-angle areas of the main flat surface, the length of the integral adhesive piece equals to the width of the electrode piece substrate 1. In a preferred embodiment, the adhesive piece 4 can be aligned with the edge of the right-angle area, so as to achieve best adhering effect of the adhesive piece 4, and prevent folding phenomenon effectively. Adopting the integral adhering manner to adhere the adhesive piece 4 at the end of the blank foil 2 can reduce the difficulty of the adhering work of the adhesive paper in actual production, and make the adhering work more simple and convenient.

The adhesive piece 4 of the present application can be a split type adhesive piece, when adhering, the split type adhesive piece covers each right-angle area of the main flat surface respectively. Adopting the split type adhesive piece provides various adhering manners of the adhesive piece, and each part of the split type adhesive piece has a small volume and is only adhered on the right-angle area of the blank foil 2, which enhances the intensity of the end of the blank foil 2, and restrains tension releasing, at the same time, saves the adhesive piece 4 effectively, without waste.

The adhesive piece 4 can be adhered on a main flat surface of the blank foil 2; in order to further strengthen the effect of restraining tension releasing by the adhesive piece 4, meanwhile strengthening the intensity of the end of the blank foil 2, the adhesive piece 4 can also be adhered on both the two main flat surfaces of the blank foil 2 correspondingly.

When the adhesive piece 4 is a split type adhesive piece, corresponding to a blank foil with two main flat surfaces, as shown in FIG. 3, the right-angle area is provided at the main flat surface, a part of the split type adhesive piece can be adhered at a right-angle area of a main flat surface, the other part is adhered at a right-angle area of the other main flat surface, two parts of the split type adhesive piece are adhered respectively at the right-angle areas of the two main flat surfaces which do not correspond with each other, which means the two parts are located respectively at two flat surfaces, In some embodiments, two parts of the split type adhesive piece are aligned with and adhered at the edge of a right-angle area, respectively.

The split type adhesive piece can be applied widely, when adhering an integral adhesive piece, at the same time, a part of a split type adhesive piece can be further adhered at the right-angle area which needs to be adhered, which does not only save the adhesive piece 4 but can also strengthen the intensity of the end of the blank foil 2 effectively, thus, the specific adhering manner of the adhesive piece 4 can be determined according to the requirements of actual production.

In order to reduce the thickness increasing degree of the electrode piece and reduce, in a certain extent, the influence on the battery capacity density as much as possible, the present application adopts an adhesive piece 4 with thickness less than the thickness of the electrode piece substrate 1.

The part of the blank foil 2 of the present application is located at a side of the electrode tab 3 that is away from the electrode piece substrate 1, the size of this part along the length direction of the electrode piece substrate 1 is 1-5 times of the size of the adhesive piece 4 along the same direction. If the width of the adhesive piece 4 is so narrow that the folding problem of the electrode piece cannot be solved, however, of the adhesive piece 4 is so wide that waste problem may occur.

For the split type adhesive piece, the size of each part thereof along the width direction of the electrode piece substrate 1 is at least ¼ of the width of the electrode piece substrate 1, thus it is can be guaranteed that the electrode piece will not fold when feeding during coiling. The adhesive piece 4 of the present application can be adhesive paper, which can specifically be polyethylene terephthalate adhesive paper, that is, an adhesive paper of PET material, which has higher viscosity, and has characteristics of acid-alkali resistance, corrosion resistance and high temperature resistance, and can be adhered stably on the blank foil 2 for a long time, thus can keep the right-angle area smooth and unfolded when coiling.

The Li-ion battery electrode piece provided by the present embodiment, through adhering an adhesive piece 4 on the end of blank foil 2, avoids the blank foil 2 on the front end of the electrode piece from being deformed and folded effectively, and improves the phenomenon of the convex in battery core appearance and bad streak.

The above are just the preferred embodiments of the present application, and will not limit the present application, for those skilled in the art, the present application can have various modifications and variations. Any modifications, equivalent replacements and improvements made within the spirit and principle of the present application shall all fall in the protection scope of the present application.

What is claimed is:

1. A Li-ion battery electrode piece comprising:
an electrode piece substrate, a blank foil, at least one adhesive piece, and an electrode tab; the electrode piece substrate having a length between two ends defining a length direction and a width defining a width direction;
the blank foil being arranged on one end of the electrode piece substrate extending along the length direction of the electrode piece substrate;
the blank foil comprising a first end and a second end, the first end being away from the one end of the electrode piece substrate in the length direction of the electrode piece substrate, and the second end being close to the one end of the electrode piece substrate;
the blank foil containing a plurality of corners at the first end, edges of the first end forming a right angle at each of the plurality of corners forming a right-angle area at each of the plurality of corners; the at least one adhesive piece being adhered to the right-angle area;
wherein the blank foil is a sheet structure, the blank foil has two opposite main flat surfaces and is located at the first end, the right-angle area is located on one of the two opposite main flat surfaces, and the at least one adhesive piece is adhered to at least one of the two opposite main flat surfaces;
each of the at least one adhesive piece has a first edge aligned with one of the edges of the first end;
the right-angle area is uncovered by the at least one adhesive piece; and
the electrode tab is arranged on the blank foil, and a distance between the electrode tab and the first end of the blank foil is 1-5 times of a length of one of the at least one adhesive piece along the length direction of the electrode piece substrate.

2. The Li-ion battery electrode piece according to claim 1, wherein, the at least one adhesive piece is aligned with edges of the right-angle area.

3. The Li-ion battery electrode piece according to claim 1, the electrode tab is arranged on the blank foil, and a distance between the electrode tab and the first end is 2-5 times of a length of one of the at least one adhesive piece along the length direction.

4. The Li-ion battery electrode piece according to claim 1, wherein each of the at least one adhesive piece is a single adhesive piece, and the single adhesive piece is adhered to the blank foil along a width direction of the electrode piece substrate and fully covers the right-angle area.

5. The Li-ion battery electrode piece according to claim 1, wherein a thickness of the at least one adhesive piece is less than a thickness of the electrode piece substrate.

6. The Li-ion battery electrode piece according to claim 1, the distance between the electrode tab and the first end of the blank foil is 3-5 times of the length of the one of the at least one adhesive piece along the length direction of the electrode piece substrate.

7. The Li-ion battery electrode piece according to claim 1, wherein one of the at least one adhesive piece is an adhesive paper, and the adhesive paper is a polyethylene terephthalate adhesive paper.

8. A Li-ion battery electrode piece comprising:
an electrode piece substrate, a blank foil, at least one adhesive piece, and an electrode tab;
the electrode piece substrate having a length between two ends defining a length direction and a width defining a width direction;
the blank foil being arranged on one end of the electrode piece substrate extending along a length direction of the electrode piece substrate;
the blank foil comprising a first end and a second end, the first end being away from the one end of the electrode piece substrate in the length direction of the electrode piece substrate, and the second end being close to the one end of the electrode piece substrate;
the blank foil containing a plurality of corners at the first end, edges of the first end forming a right angle at each of the plurality of corners forming a right-angle area at each of the plurality of corners, the adhesive piece being adhered to the right-angle area;
wherein the blank foil has two opposite main flat surfaces, the adhesive piece is adhered to at least one of the two main flat surfaces, the adhesive piece comprises a first adhesive piece and a second adhesive piece separated from the first adhesive piece, the right-angle area comprises a first right-angle area and a second right-angle area, the first adhesive piece covers the first right-angle area;
the first adhesive piece and/or the second adhesive piece has a first edge aligned with one of the edges of the first end;
the second adhesive piece covers the second right-angle area; and
the electrode tab is arranged on the blank foil, and a distance between the electrode tab and the first end of the blank foil is 1-5 times of a length of one of the first adhesive piece and the second adhesive piece along the length direction of the electrode piece substrate.

9. The Li-ion battery electrode piece according to claim 8, wherein the first adhesive piece and/or the second adhesive piece is aligned with edges of the right-area.

10. The Li-ion battery electrode piece according to claim 8, wherein a thickness of the first adhesive piece or the second adhesive piece is less than a thickness of the electrode piece substrate.

11. The Li-ion battery electrode piece according to claim 8, wherein a distance between the electrode tab and the first end of the blank foil is 2-5 times of a length of one of the first adhesive piece and the second adhesive piece along the length direction of the electrode piece substrate.

12. The Li-ion battery electrode piece according to claim 8, wherein a width of the first adhesive piece is equal to or greater than ¼ times of a width of the electrode piece substrate along the width direction of the electrode piece substrate, and a width of the second adhesive piece is equal to or greater than ¼ times of the width of the electrode piece substrate along the width direction of the electrode piece substrate.

13. The Li-ion battery electrode piece according to claim 8, wherein a distance between the electrode tab and the first end of the blank foil is 3-5 times of a length of one of the first adhesive piece and the second adhesive piece along the length direction of the electrode piece substrate.

14. The Li-ion battery electrode piece according to claim 8, wherein the first adhesive piece or the second adhesive piece is an adhesive paper, and the adhesive paper is a polyethylene terephthalate adhesive paper.

15. A Li-ion battery electrode piece comprising:
an electrode piece substrate, a blank foil, and at least one adhesive piece;
the blank foil being arranged on one end of the electrode piece substrate along a length direction of the electrode piece substrate;
the blank foil comprising a first end and a second end, the first end being away from the one end of the electrode piece substrate, and the second end being close to the one end of the electrode piece substrate;
the blank foil containing a plurality of corners at the first end, edges of the first end forming a right angle at each of the plurality of corners forming a right-angle area at each of the plurality of corners, the at least one adhesive piece being adhered to the right-angle area;
wherein the blank foil is a sheet structure, the blank foil has two opposite main flat surfaces and a side surface disposed between the two opposite main flat surfaces and is located at the first end, the right-angle area is located on one of the two opposite main flat surfaces, and the at least one adhesive piece is adhered to at least one of the two opposite main flat surfaces;
each of the at least one adhesive piece has a first edge aligned with one of the edges of the first end;
the side surface uncovered by the at least adhesive piece; and
wherein the at least one adhesive piece comprises a first adhesive piece arranged on a first main flat surface of the two opposite main flat surfaces, and a second adhesive piece arranged on a second main flat surface of the two opposite main flat surfaces, the right-angle area comprises a first right-angle area on the first main flat surface and a second right-angle area on the second main flat surface, the first adhesive piece covers the first right-angle area, the second adhesive piece covers the second right-angle area, and the first right-angle area and the second right angle area are staggeredly arranged on the blank foil.
